(19) United States
(12) Patent Application Publication
(10) Pub. No.: US 2008/0092650 A1
(43) Pub. Date: Apr. 24, 2008

(54) Buoyancy measuring and testing tank

(76) Inventor: Curtis Charles Courian, San Diego, CA (US)

Correspondence Address: Curtis Courian, 712 W. 13th St., Medford, OR, 97501-3426, US

(21) Appl. No.: 11/585,314

(22) Filed: Oct. 24, 2006

(51) Int. Cl. G01N 9/02

(52) U.S. Cl. 73/433

(57) ABSTRACT

Currently no one has thought to try to measure the buoyancy, or in this case, the weight of upward force produced by manufactured products submerged in water. Trial and error or trying to “add” up the density of dissimilar materials has been the way items were tested. Because many products are made up of numerous materials, some very buoyant and some not buoyant, the need for a piece of testing equipment that can measure an entire object is essential. Taking all materials into account when assessing buoyancy can help to ensure a safe product (being able to float the intended weight) and provide hard data for product liability (proving the product can perform under intended conditions).

### CROSS-REFERENCE TO RELATED APPLICATIONS

Application # 20030200037

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF THE INVENTION

This application applies to buoyant objects and specifically to flotation in items like but not limited to life jackets (PFD's), water sport crafts (surfboards), small boats, jet skis, floating docks and any item where closed cell foam or air is used for buoyancy (US Patent Classification 073 sub class 437)

Presently there are numerous floating objects serving the purpose of carrying a certain amount of weight. Weather it is the body weight of a person on a recreational watercraft or the weight borne by a floating dock these structures or craft must be able to withstand the weight that they are designed to hold.

Most of the aforementioned items use some sort of closed celled foam or hollow air space as the flotation. Closed cell foam comes in a multitude of forms and densities and as a result can have significant differences in their buoyancy and vary greatly in their ability to carry weight.

Life jackets, inflatable boats, positive flotation for small boats, water sport crafts, surfboards, personal water crafts, kayaks, and floating docks are just a few examples of devices using air and more specifically closed cell foam for flotation. One thing common to all items listed is that there are several materials used in each of their construction. Not all the materials used are less dense than water and consequently will sink if not accompanied by the foam for flotation.

Safety and product liability are a very serious concern for producers of any product used to support weight over water. It would be safe to say that these concerns would be of top priority for these manufacturers. Each product would have extensive engineering to prove that there was enough positive flotation to support the intended weight.

Unfortunately with the complexities of construction and the unknown possible misuse of the product it is unreasonable to expect a engineer in a office to be able to account for variations in assembly and change of materials when assigning the amount of flotation needed.

I believe a more comprehensive test must be done to account for the buoyant and non buoyant materials so a manufacturer can be certain that the product can indeed support the weight intended. This test would be on the finished product and could give a exact “buoyancy rating” that could prevent an overweight situation leading to serious injury or death.

There is no prior art found of any testing equipment to measure buoyancy. Furthermore there isn't a standard on which different items can be assigned a buoyancy “rating” to designate their ability to support weight. Standardized testing equipment and a standardized buoyancy rating test could be quite useful for matching the user to their equipment based on their body weight. Manufacturers liability for many products could be limited because maximum weight limits for buoyant items would be known and marked accordingly.

### BRIEF SUMMARY OF THE INVENTION

The invention is a piece of testing equipment that can accurately measure the flotation or buoyancy of a item using a force gauge or weight scale to measure the force or upward pressure required to submerge an object in water. By submerging the entire finished product you would get a relative buoyancy for the entire item, taking into account all the different materials that it is made of and giving a overall buoyancy rating. The testing tank would give an accurate reading of the load that the finished product could support. This new way of measuring is superior to trying to assess the weight and densities of all the materials that make up the product and mathematically figuring out the buoyancy. Being able to accurately test the buoyancy of surfboards, for instance, would make the selection process far easier and the proper board for a particular body weight could easily be achieved.

### BRIEF DESCRIPTION OF THE SEVERAL VIEWS OF THE DRAWING

FIG. 1A: (8) A tank with a length, width and depth large enough to fit and submerge a range of objects. (4) A main support beam and assembly that would carry the scale and be able to withstand the upward force created by pushing on the buoyant item to submerge it. (5) A platform for the weight scale to bear against. (6) A weight scale with (2) digital display to record the force required to submerge the object. (7) A EPS foam “foot” to push directly on the object. (1) A wedge and slide mechanism with hand grip to exert the force required to submerge the object and hold it in place while testing. (3) Springs to lift the weight of the scale above the object for removal after testing.

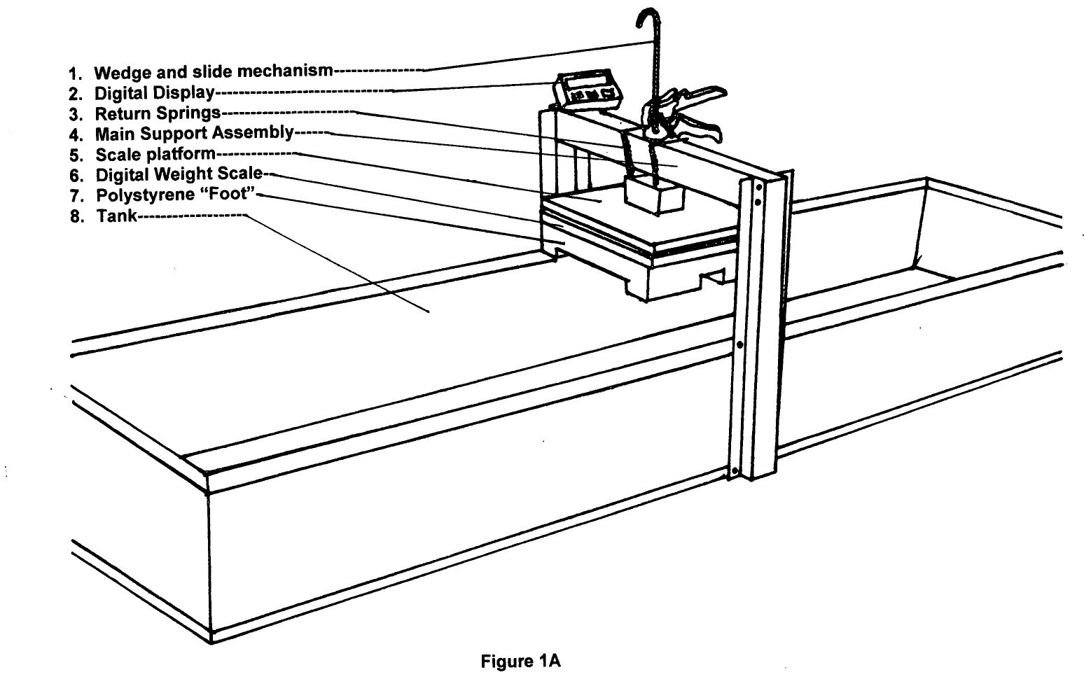

### DETAILED DESCRIPTION OF THE INVENTION

To use the testing tank an item would be placed into the testing tank (8) filled with water. The “wedge slide mechanism” (1) supported by the main support assembly (4) would bear on the scale platform (5) that would in turn press against the weight scale (6) and force the item under water. To protect the object being tested and to not add weight to the object, a polystyrene foot (7) is situated between the weight scale and the object. To ease loading and unloading the testing tank a set of return springs (3) are used to raise the weight scale. The digital display (2) would record the amount of force/weight required to hold the object submerged. A pound, kilogram or other proprietary unit of measure would be permanently fixed to the object giving it a “buoyancy rating”.

This way of testing buoyancy is completely new and novel. Objects with a buoyancy rating would be safer to use because a accurate maximum weight would be known to the user. Other recreational type crafts could be matched to the users body weight and ability. Some product liability cases could be avoided because there would be more accurate guidelines for maximum weight used.

The process must include submerging the object. There are other means of making a basic calculation of flotation (volume, density, weight, mass etc.). The pounds or kg to submerge an object also is affected by the materials and density. Other ways of calculating the buoyancy would not take into account the specific materials of each item.

The Invention: To get accurate testing results, the testing equipment must be constructed in a like manner. The preferred embodiment is as follows.

A waterproof tank large enough in length, width and depth to accept a number of different size objects. A tank strong enough to hold the weight of the water. Many materials would be acceptable. Aluminum would be preferred because of the strength to weight ratio. Plastic or wood with a plastic liner could also be used.

A center assembly to carry the weight scale and submerge the object by extending a rod to force the object underwater. The center assembly must be strong enough to carry the upward force that is generated by the buoyancy of the object. This piece of the testing equipment should be made of extruded aluminum box section and machine screwed to two vertical “hat” profiles which are in turn screwed to the sides of the tank near the center.

Objects to be tested need to be submerged and held under water which requires a mechanism that has the power to push and hold the object. With smaller testing tanks, a wedge and slide mechanism would be preferred (similar to a caulking gun). These types of mechanisms use a hand grip lever and 2 wedges. One levered wedge pushes the rod forward and the other wedge holds the rod in place or can release the rod. These mechanisms are simple and can transfer hand grip pressure into force of nearly 100 lbs. For larger testing tanks a hydraulic, pneumatic or gear driven press would be needed to withstand the upward force.

A weight scale with a digital display would be preferred over a analog display.

The weight scale should be suited to the size of the tank and to the buoyancy load that would be generated by the object being tested. Because this type of testing equipment would be used as part of the original manufacturing testing process the scale capacity would be matched to the item being tested thus avoiding a overloading situation.

A set of four return springs are needed to raise the scale to clear the tested object for exit from the tank. The springs need to be strong enough to raise the weight of the scale, scale platform and the foam “foot”. The springs are attached to the center cross bar and the scale platform.

The scale platform is the link between the “press” mechanism and the weight scale. This platform must be suited for the size of the scale and be strong enough to withstand the upward force. The return springs would be attached to the top of the scale platform. Wood or aluminum would be the preferred material.

The foam foot serves three purposes. First, it serves as a non scratch element to press on the object to be submerged. Second, the “foot” provides a gap between the weight scale and the water level to keep it dry and finally the “foot” needs to be made out of a very light foam so as not to add extra weight to the object being tested. Polystyrene would be the preferred material. The foot is mechanically attached to the weight scale and platform with Velcro straps.

This testing tank is unique because it is able to test buoyancy and assign a weight factor to it. It is further unique in the fact that it can test the buoyancy of items made of several materials simultaneously. The need to calculate each material and add the positive and negative flotation is replaced by one simple test which takes all factors into account. Obviously the design of the testing tank would need to be suited to the particular requirement. What works for a boat would not be suited to test life jackets. This testing equipment could be especially valuable for boats where expanded foam is used for extra flotation in voids in the hull. It is impossible to calculate the buoyancy of the irregular areas where the foam is placed. A second potential area of use would be to match the buoyancy of a surf or sail board to a particular body weight of the user.

What I claim is:

1. A testing apparatus using a weight scale to measure buoyancy when a object is submerged in water.

2. A testing apparatus made up of a waterproof tank, a press assembly and a weight scale for the sole purpose to measure the force required to submerge a buoyant object.

3. A piece of testing equipment recited in claim 2, wherein a hand powered wedge and slide rod assembly is used to force and hold the object being tested underwater.

4. A piece of testing equipment recited in claim 2, wherein a hydraulic, pneumatic, gear or lever system is used as a means to submerge and hold the object being tested underwater
